(19) United States
(12) Patent Application Publication
(10) Pub. No.: US 2017/0340155 A1
(43) Pub. Date: Nov. 30, 2017

(54) Key Caddy

(71) Applicant: Coby Shane Simpson, Indianapolis, IN (US)

(72) Inventor: Coby Shane Simpson, Indianapolis, IN (US)

(21) Appl. No.: 15/675,753

(22) Filed: Aug. 13, 2017

(51) Int. Cl. A47G 29/10; F16M 13/02

(52) U.S. Cl. CPC A47G 29/10; F16M 13/02

(57) ABSTRACT

The following embodiments of the Inventive disclosures made herein comprise various elements of the Key Caddy, for daily use of a convenient location to place and retrieve common household and vehicle keys.

In one or more of the embodiments of the inventive disclosure made herein, the Key Caddy is designed for ease of installation with the use of any existing light switch plate of the user's preference, and requires no special hardware to install. A screwdriver is all you need for installation.

In one or more of the embodiments of the inventive disclosure made herein, the Key Caddy has the main support housing, backing spacer, and (3) key hooks, all comprised of one piece. The main support housing is designed within 1/32″ of an inch precision, and to fit securely in place to any common household light switch plate by using the existing center screw that attaches the existing light switch plate itself

In one or more of the embodiments of the inventive disclosure made herein, the Key Caddy includes a backing spacer within the embodiment of the main support housing that stabilizes the holder, and fills in the space below the switch plate created by the thickness of the existing switch plate protruding from the wall. This is approximately 3/16″ of an inch. This spacer also is sized to almost the same width of the switch plate and prevents rotation clockwise or counter clockwise when excessive key weights are applied at one end or the other on the hooks provided. The existing switch plate thickness provides this anti-rotation element.

In one or more of the embodiments of the inventive disclosure made herein, the Key Caddy provides (3) key hooks that are sized and adapted for extra strength support for larger key rings with many keys, as well as those that are smaller. The hooks are designed for supportive strength at the bottom and are tapered at the top to accommodate smaller key rings. The hooks are separated to allow both smaller and larger key arrangements. The hooks are placed purposely lower than the existing switch plate housing, and at the bottom of the embodiment, to ensure that access to the actual on/off switch provides ample finger clearance without coming into contact with the hanging keys, when turning on and off the light.

In one or more of the embodiments of the inventive disclosure made herein, the Key Caddy's main housing is designed with rounded edges to prevent snagging, and without pointed obstructions to prevent any minor scrapes or pinches of the hand when in use.

These and other objects of the invention made herein will become apparent in the design intent of this invention. Generally, when placing the Key Caddy on the most frequently used light switch of any household, and by turning on a light that you most often access, you will be reminded immediately of your keys that are hanging on it.

### BACKGROUND

With conventional key holders you have to buy screws along with the key holder itself. You have to make new holes on the walls for the holder and sometimes use inserts for those screws depending on whether attached to drywall or wood. When you want it removed, you now have to cover up the new holes with plaster and paint, or patch holes made into wood which usually requires sanding and stain matching. By using an existing fixture within your home and the hardware included already on that fixture, you eliminate the sometimes tedious task of measuring and locating holes for hanging an item, and also eliminate the even more tedious task of touchup requirements to the wall, if you remove the item for any reason.

Typically, keys are the item most often lost or misplaced within a household because they can end up on kitchen counters, desk, coffee tables, bedroom chests, etc. In your daily haste, emptying your pocket contents as your routine usually encompasses, you may place pocket change, keys, cell phone, and other miscellaneous items all together in a heap at locations that are most convenient at the time, or because of what you are doing. Sometimes these items are placed in different places throughout the home, causing frustration when you need to retrieve them in a hurry. By placing a holder for some of such items in a place on the wall that is accessed more than others, it can be viewed as a reminder to not forget them, as well as knowing where they are when you turn on the most used light in your house.

For example, typically the kitchen is accessed every morning and late at tonight before bedtime. When the light is turned on, you see the keys, and you are reminded immediately of those keys, in the manner described above. In the same respect, when you leave the kitchen at night and turn off the switch, you see where you left them, and this seems to stick out in your mind, when the next morning arrives. Many can and may choose a different location for this placement, as to different lifestyles may call for it. Consistency in organization of items such as keys, built around consistent habits that we do every day, such as turning on certain lights, is where the intent lies within the thoughts related to the use of this item.

### FIELD OF THE DISCLOSURE

The disclosures made herein relate generally to a key holder for all of the household keys, or automobile keys, for a convenient location to place and retrieve within an area that is most often accessed within your home or office, and for reminding anyone to not forget their keys.

### BRIEF DESCRIPTION OF THE DRAWINGS

The drawings show a form of the invention that is presently preferred. However, the invention is not limited to the precise arrangement of the drawings. To elaborate, (2) hooks may be used at times for the invention embodiment, and the main housing and spacer plate may be adjusted to fit less common household switch plates, such as customized ones in high end homes and offices. The embodiment of the invention will overall and for the most part remain the same, with only slight adjustments to fit a wider variety of customized and specialty manufacturers of such electrical outlet covers and switch plates.

FIG. 1 presents a rear perspective view of the embodiment, showing the spacer plate (3) and main housing plate (1). The 3.57 mm hole (4) for the screw used in home switch plates is shown near the top and centered length wise on the housing plate (1). One hook (2) can be seen in this view, although there are three hooks total on the far side.

FIG. 1A presents a rear perspective shaded view of the embodiment, showing all the embodiments referenced in FIG. 1.

FIG. 2 presents a front perspective view of the embodiment, showing the main housing plate (1). The 3.57 mm hole (4) for the screw used in home switch plates is shown near the top and centered length wise on the housing plate (1). The countersunk hole of 4.76 mm (5) is shown centered on the 3.57 mm hole. This countersink prevents the edges of the screw being exposed. The total of three hooks (2) can be seen in this view.

FIG. 2A presents a front perspective shaded view of the embodiment, showing all the embodiments referenced in FIG. 2.

FIG. 3 presents a top view of the embodiment, showing the main housing plate (1), the three hooks (2), the backing spacer (3), the 3.57 mm hole (4), and the countersunk 4.76 mm hole (5). The slightly shaded areas on the main housing and the hooks represent the rounded edges within the embodiment.

FIG. 4 presents a front view of the embodiment, showing the main housing plate (1), the three hooks (2), the backing spacer (3), the 3.57 mm hole (4), and the countersunk 4.76 mm hole (5).

FIG. 5 presents a rear view of the embodiment, showing the main housing plate (1), the spacer plate (3), and the 3.57 mm hole (4) for the screw used in existing home switch plates which is shown near the top and centered length wise on the housing plate (1). Two hooks (2) can be partially seen in this view, although there are three hooks total on the far side.

FIG. 6 presents a side view of the embodiment, showing the main housing plate (1), one hook (2), with the other two hooks directly in line with it beyond, the backing spacer plate (3), and the approximate location of the 3.57 mm hole (4) for the screw used in home switch plates.

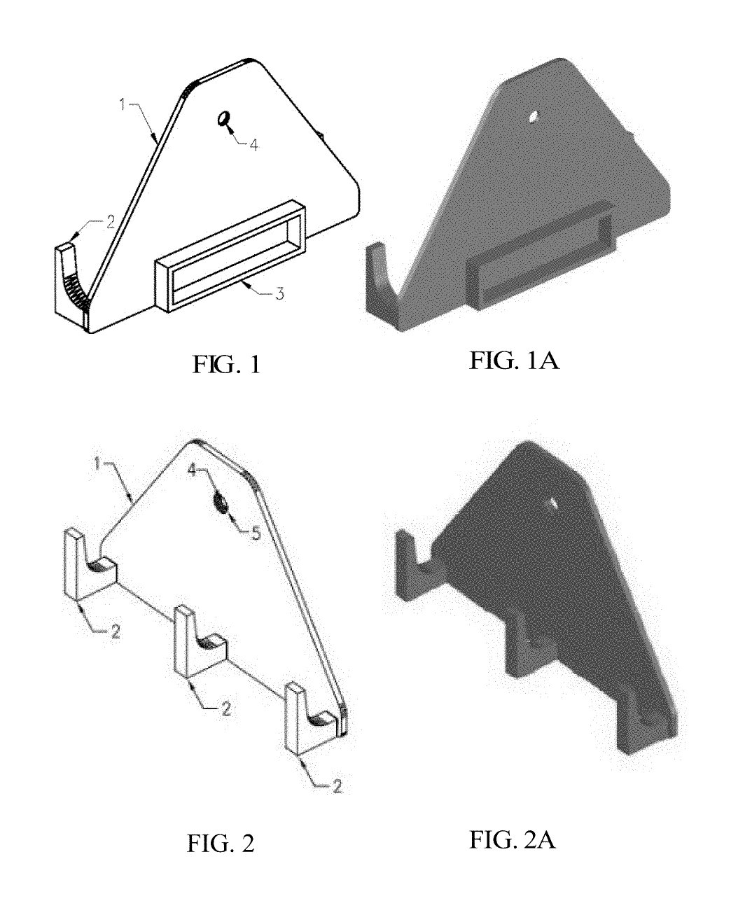

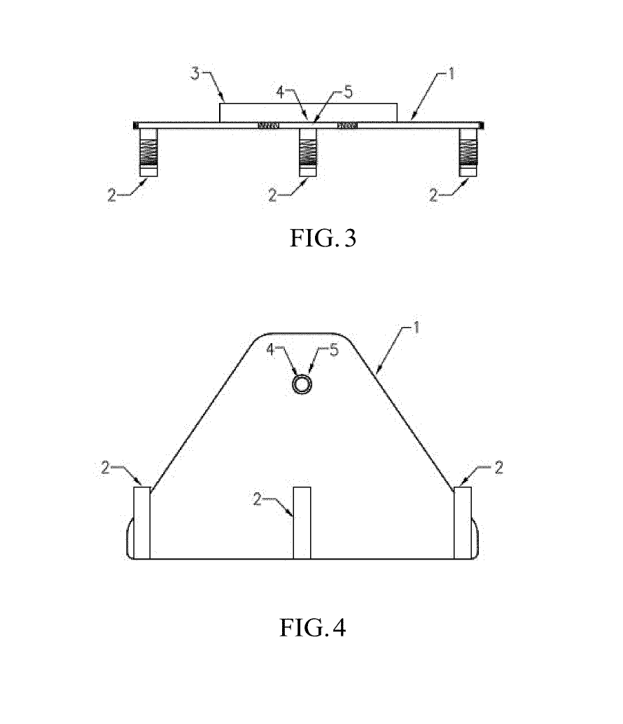

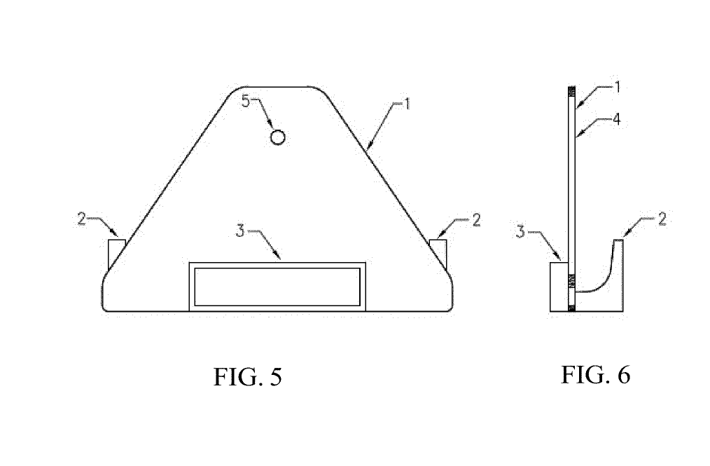

In the preceding detailed description, reference has been made to the accompanying drawings that form a part hereof, and in which are shown by way of illustration specific embodiments in which the invention may be practiced. It is understood that other suitable embodiments may be utilized and that logical, material, and mechanical changes made be made without departing from the spirit or scope of the invention. The preceding detailed description is therefore, not intended to be limited to the specific forms set forth herein, but on the contrary, it is intended to cover such alternatives, modifications, and equivalents, as can be reasonably included within the spirit and scope of the appended claims.

What is claimed:

1. A key holder for all of the household, automobile, and personal keys, for convenient location to place and retrieve within an area that is most often accessed within your home or office.

2. A key holder that is designed to be attached to a standard household light switch, and easily placed using only a screwdriver, and by utilizing the existing screw that is already part of the embodiment of any standard light switch.

3. A key holder that also serves as a reminder, when it is placed on the most used light switch in your home or office.

4. A key holder that incorporates (3) hooks for multiple sets of keys, spaced apart for ease of retrieval and convenience.

5. A key holder whose embodiment of parts of which form the entire housing, have rounded and gently tapered edges for prevention of clothing, finger ring snags and skin pinches while placing or retrieving keys.

6. A key holder that holds multiple key sets of which may be on separate key rings.

7. A key holder that is strong and sturdy, and whose secure hook embodiments have been tested for weight beyond the normal weight of large key sets.

8. A key holder whose housing incorporates a spacer plate to maintain a smooth and continuous flat transition between existing light switch depth and the wall that the light switch is on, and also prevents rotation when unequal key weight is placed on the hook embodiments.

9. A key holder according to claim 1 thru claim 8 wherein said housing has dimensions of 3 ½ inches wide, 2 ¼ inches height, and 1/16 inch thick. Varying thickness beginning with main housing plate of 1/16 inch thick with spacer combined that equals a thickness of ¼ inch, of which the spacer plate embodiment is 3/16 inch deep. The overall shape is semi-triangular in nature with ¼ inch radius rounded edges, and the top of the main housing plate designed with a flat 1 inch horizontal finish rather than a sharp triangle vertex. Hook embodiments protruding from the main housing plate are ½ inch at the base perpendicular to the main housing plate, and 5/32 inch thick. The top of the base of the hook tapers gradually to an inside radius of 1″, and continues to taper to top of hook, which is 1 1/16 inch from base to top. Top of hook has dimensions of 3/32 inch perpendicular to main housing plate and 5/32 inch thick which is maintained throughout the hook. The spacer plate embodiment on the back of the main plate housing is 3/16 inch deep, 1 ¾ inch in length, and ½ inch in height. The Inside of the spacer plate is hollow with walls around the perimeter of 1/16 inch thick. The countersunk hole is centered on the main housing plate length wise and is ½ inch from top of main housing plate. The main screw hole is a 9/64 inch (3.57 mm) diameter hole, and the countersunk hole on the front of the main housing plate is a 3/16 inch (4.76 mm) diameter hole, with a depth of 1/32 inch (.79 mm).
